(19) United States
(12) Patent Application Publication
(10) Pub. No.: US 2006/0213782 A1
(43) Pub. Date: Sep. 28, 2006

(54) Method and device for dissociating carbon dioxide molecules

(75) Inventor: Burnard P. Bockris, Gainesville, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: World Hydrogen, Inc, Gainesville, FL (US)

(21) Appl. No.: 11/085,851

(22) Filed: Mar. 22, 2005

(51) Int. Cl. B01D 53/32; C25B 9/00

(52) U.S. Cl. 205/765; 204/242

(57) ABSTRACT

An apparatus is provided for dissociating carbon and oxygen from carbon dioxide molecules. The apparatus includes a thin plate made of a solid permeable ion-conducting membrane having a partial coating of platinum on a first side and ruthenium oxide on a second. An electric potential is applied between two surfaces of the membrane and the membrane is heated by a heating element. Carbon dioxide gas is brought into contact only with the negatively charged first side of the membrane. The oxygen atoms are put under an electric field, separate from the carbon atoms and enter the membrane, and become oxygen ions. The ions are transported across the membrane to the positively charged side, where they lose their negative charge and exit the membrane as pure oxygen. The carbon does not pass through the membrane and is left behind. The carbon is detached from the membrane and collected as powder for use or disposal.

### BACKGROUND OF THE INVENTION

1. Field of the Invention

The present invention relates generally to the disposal of carbon dioxide, and more particularly relates to a method and device for the dissociation of carbon and oxygen atoms from carbon dioxide, a byproduct of hydrogen production from coal.

2. Description of the Related Art

Crude oil is a finite resource. Estimates of the turn-over date for the rate of production of world oil vary from 2006 to 2020. The most probably date is 2011. Building of an eventual country-wide nuclear or renewable energy supply is estimated to take from at least 25 to as much as 50 years. Therefore, in this interval, coal will have to supplant the failing oil supply.

The United States has a large supply of coal. However, these supplies, along with those of other countries, are now known not to be in the earlier-estimated quantities that would last hundreds of years. The supplies will, however, provide energy in the range of at least 50 years and will cover the gap needed to build alternative/nuclear and renewable energy sources. However, the use of coal as an energy source brings with it a major disadvantage. The use of coal instead of oil and natural gas will release into the atmosphere four times more carbon dioxide (the major greenhouse gas) than an equivalent amount of energy in the form of oil and natural gas. In view of the threat of dramatic major climate changes, which are now recognized to result from a critical amount of carbon dioxide into the atmosphere, a future coal economy will be unacceptable unless the carbon dioxide is dealt with properly.

One valuable use of coal is in the production of hydrogen gas (H₂). The hydrogen is produced by grinding the coal into a powder-like consistency and then introducing super-heated steam at a high pressure. The result is CO₂ and H₂, which are filtered to remove any coal dust carried over from the reaction of the steam and coal. The CO₂ can then be satisfactorily sequestered, i.e., satisfactorily separated from hydrogen and disposed of in a permanently acceptable manner.

There are three main prior-art methods of sequestration of CO₂. The first method chemically combines the CO₂ with a partner compound. The most common of these compounds is lime (CaO). The reaction follows the following equation.
CaO+CO₂→CaCO₃

Because lime is abundant in many countries throughout the world, this solution appears to be viable. However, at least in the United States, unfavorable economics arise from the aspect of transporting millions of tons of lime per year from coastal regions to individual states where the big CO₂ producers (largely coal/electricity plants) exist. There is also a problem of finding a suitable location to dispose of the resulting calcium carbonate. Finally, there is the corresponding cost of transporting millions of tons of the resulting calcium carbonate to the chosen disposal cite.

A second method for disposing of CO₂ is placing it in the ocean at depths below about 3000 ft. At this depth, the pressure causes a hydrate to form and sink to the sea bottom. This method suffers from the disadvantage of requiring a lengthy pipeline system which would have to be built country-wide to reach the eastern and western seaboards. It is estimated that building such a pipeline would take as much as 25 years. In addition, the second method suffers from the disadvantage that the buried gas has a considerable potential of leaking, returning to the surface of the ocean, and then into the atmosphere.

The third method for disposing of CO₂ vents the CO₂ into the atmosphere. However, as noted above, carbon dioxide is the largest contributor to the greenhouse effect. In the past few years, startling and frightening facts have come to light and have been backed by several well-regarded scientific organizations. If the CO₂ concentration (now around 380 ppm) in the earth's atmosphere reaches 600 ppm, the earth's temperature will rise and cause massive melting of the world's ice. Adding the resulting water to the earth's oceans will cause a sea level rise of 20 to 30 feet the world over, causing major destruction of many coastal cities.

Therefore a need exists to overcome the problems with the prior art as discussed above.

### SUMMARY OF THE INVENTION

Briefly, in accordance with preferred embodiments of the present invention, disclosed is an apparatus for dissociating carbon dioxide molecules. In one embodiment, the apparatus comprises an ion-conducting oxygen-permeable membrane that has a first surface and a second surface, with the second surface being opposite the first surface. An electric potential is applied so that the first surface has a first voltage and the second surface has a second voltage, the second voltage being greater than the first voltage by at least 3 volts.

In one embodiment of the present invention, the first surface of the ion-conducting membrane is at least partially coated with platinum.

In another embodiment of the present invention, the second surface of the ion-conducting membrane is at least partially coated with ruthenium oxide.

In yet another embodiment of the present invention, a chamber is mechanically coupled to the first surface and CO₂ gas is placed within the chamber. The CO₂ gas contacts the first surface (its temperature having been raised to 1000° C.) of the membrane and the two O atoms of each CO₂ molecule dissociate from the C atom. The O atoms (now converted to O⁻⁻ ions) enter the first surface of the membrane, diffusing through the membrane under the applied potential, and exit the membrane at the second surface.

In one embodiment of the present invention, a heating element is coupled to the membrane and heats the membrane.

In some embodiments of the present invention, at least one of an ultrasonic wave generator, a vibration generator, and a scraper coupled to the first surface of the ion-conducting membrane is provided for causing at least one carbon deposit to detach from the first surface of the ion-conducting membrane.

Another embodiment of the present invention provides a method for dissociating carbon dioxide molecules. An ion-conducting membrane having a first surface and a second surface opposite the first surface is heated. A negative charge is applied to the first surface of the ion-conducting membrane and a positive charge is applied to the second surface of the ion-conducting membrane. Carbon dioxide gas is applied to the first surface of the ion-conducting membrane.

In one embodiment of the present invention, a carbon byproduct of the dissociation is removed from the chamber.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating one embodiment of an ion-conducting membrane in accordance with the present invention.

FIG. 2 is a diagram illustrating a chamber coupled to the ion-conducting membrane of FIG. 1 in accordance with one embodiment of the present invention.

FIG. 3 is a diagram illustrating a vibration generator coupled to the ion-conducting membrane of FIG. 1 in accordance with one embodiment of the present invention.

FIG. 4 is a diagram illustrating an array of ion-conducting membranes arranged on a circular plate in accordance with one embodiment of the present invention.

FIG. 5 is a diagram illustrating a scraper and an ultrasonic wave generator coupled to the ion-conducting membrane of FIG. 1 in accordance with one embodiment of the present invention.

FIG. 6 is a flow diagram of a method of dissociating carbon dioxide in accordance with a preferred embodiment of the present invention.

FIG. 7 is a diagram illustrating a Faraday homopolar voltage generator in accordance with one embodiment of the present invention.

FIG. 8 is a graph illustrating free-energy temperature for the formation of CO₂ and zirconia-oxide without the effect of an applied electric potential.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to one embodiment, overcomes problems with the prior art by efficiently disassociating carbon dioxide molecules (CO₂) into the environmentally friendly elements of oxygen (O₂) and carbon (C).

It is well known that CO₂ is a stable molecule and therefore difficult to dissociate. A thermodynamic analysis, shown in FIG. 8, of the standard free energy of the formation of CO₂ from C and O₂ shows that the formation of CO₂ is highly favored and the reverse reaction cannot occur unless forced to do so by means of an electrical potential, which is not applied for the reactions in the graph. The present invention utilizes a solid electrolyte, raised to a temperature of more than 1000° C., with an applied electrical potential (calculated from the chart of FIG. 8 to be at least 3 volts depending on the rate of production of C and O₂ from CO₂ desired.)

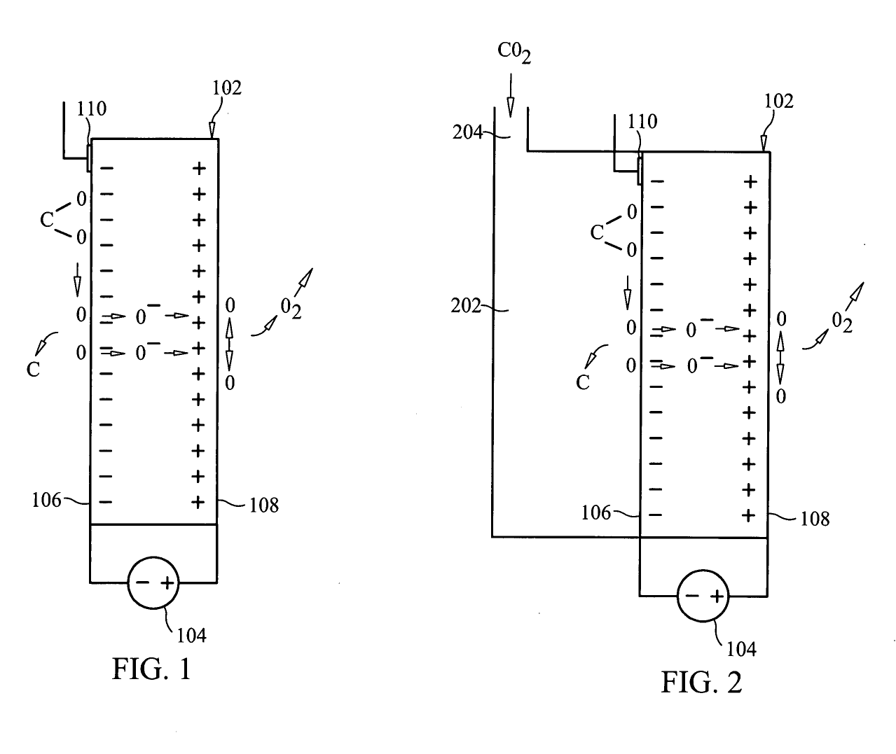

Described now are exemplary apparatuses according to embodiments of the present invention. Referring to FIG. 1, a side view of a solid state permeable ionic conductor 102 is shown. The ionic conductor 102 is in the form of an ion-conducting membrane having two surfaces 106 and 108. An electric potential is applied to the ionic conductor 102 from a power source 104. The power source 104 applies a negative voltage to a first surface 106 of the ionic conductor 102 and a positive voltage to a second surface 108 of the ionic conductor 102. A heating element 110 is also coupled to the ionic conductor 102.

Several substances can be used for the ionic conductor 102. One substance that shows ionic conduction when raised above room temperature is zirconium oxide, ZrO₂. In a preferred embodiment of the present invention, the ionic conductor 102 includes yttrium oxide (Y₂O₃) mixed (potentially alloyed) with ZrO₂, which provides increased stability over ZrO₂ alone. Another material that has been found to be effective is U₃O₈, an oxide of U. It should be noted that in practice, the non-radioactive isotope of U is used.

At least two electrodes are necessary to form an electrochemical cell. In the present invention, two electrodes are formed by plating out, or evaporating noble metals onto the surfaces 106 and 108 of the conductor 102. In one preferred embodiment of the present invention, the first surface 106 is provided with platinum applied in spots and not completely coving the entire surface. Ruthenium oxide is similarly applied in spots to the second surface 108. These metallic partial coatings act as electrodes and catalytically allow the power source 104 to better electrically attach to the surfaces 106 and 108.

When carbon dioxide (CO₂) comes into contact with the platinum on the first surface 106 of the ionic conductor 102, the oxygen (O) is ionized to O⁻⁻. If a potential 104 of at least 3 volts is applied across the conductor 102, the O⁻⁻ enters the solid conductor 102 and undergoes an electrochemical transport under the applied electric fields The O⁻⁻ travels across the solid membrane 102 and exits on the second surface 108, which is positively charged. As the oxygen reaches the positive surface 108, it gives up its negative charge, becomes O, and then combines with the aid of ruthenium oxide or other catalyst provided on the surface of the second side of the ionic conductor, whereupon the oxygen atoms produced by the de-ionization of the O⁻⁻ become oxygen atoms (O) and then finally combine to molecular oxygen, O₂. Finally, the environmentally harmless O₂ is released into the atmosphere and pure carbon (C) is left on the first surface 106.

The thickness of the ionic conductor 102, which functions as a membrane for passing oxygen atoms, is determined by balancing minimum thickness (hence, maximum electric field for a given applied potential) and mechanical stability of the oxide. In a preferred embodiment of the present invention, the ionic conductor 102 has a thickness of about 1-2 mm.

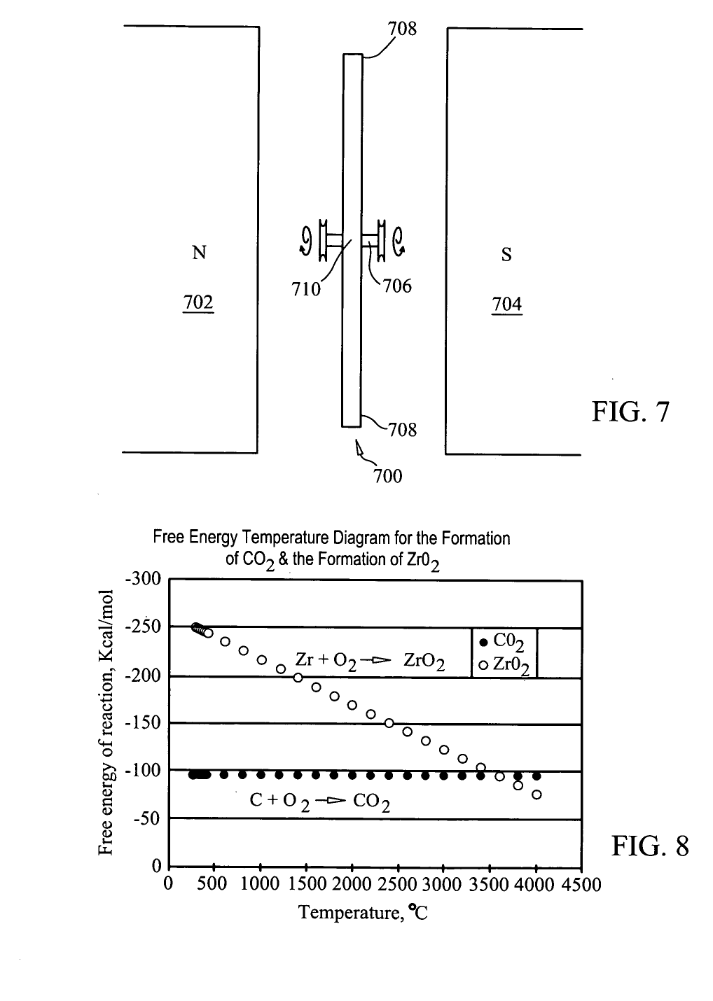

The electric potential applied to the conductor 102 can be generated by any power source capable of producing a DC voltage, such as a battery, DC power supply, or others. In a preferred embodiment of the present invention, the electric potential is at least 3 volts. In one embodiment of the present invention, the DC source is a Faraday Homopolar generator, which is a rotating disk within a magnetic field and is known by those of skill in the art and explained in Use of Homopolar Generators for Hydrogen Production, Intl. J. of H energy, H. Ghoroghchian & J. O'M Bockris, Pergamon Press, Vol 10, 1984, 101, which is herein incorporated by reference in its entirety. FIG. 7 shows a Faraday Homopolar generator having a disk 700 that is situated between a north pole 702 and a south pole 704 of a magnet. A magnetic field exists between the two poles 702 and 704. The disk 700 is then spun so that it rotates along an axis 706 and is constantly moving within a magnetic field. The movement generates a potential that gradually increases from the center of the disk 710 (which is always at 0 volts) to the outer edge 708 of the disk 700. The potential at the outer edge is at least 3 volts. The rotational force for the disk in the Faraday Homopolar generator can be generated by any power source, but is preferably driven by wind, hydro, or a solar power source. Therefore, in at least one embodiment, the present invention can be driven entirely without the use of fossil fuels.

The electric potential generated by the homopolar generator is channeled to the electrodes of the present invention by a set of metal leads that contact the disk 700. The leads can be brushes, metal wheels, or other devices that allow the disk 700 to spin along its axis 706.

The dissociation of CO₂ depends sharply on temperature and the rate at which dissociation occurs, increases with temperature. Therefore, the heating element 110 is provided for increasing the temperature of the conductor 102 and thus accelerating the dissociation process. The heating element 110 can include a laser, a resistive heater, a directed convection flow, and other heating devices. In one embodiment of the present invention, the heating element 110 raises the working temperature of the ionic conductor 102 to at least 1000° C. Other temperatures are chosen based upon the material of the ionic conductor 102 and the desired speed of the process. Thus, temperatures of up to 1750° C. can be used with a conductor of U₃O₈—Y₂O₃.

Referring now to the embodiment of FIG. 2, the ionic conductor 102 is coupled to a gas chamber 202. The first surface 106 of the ionic conductor 102 forms one wall of the gas chamber 202. The gas chamber 202 is provided with an input 204 for inputting CO₂ in gaseous form. In practice, the chamber can be any boundary that allows CO₂ gas to contact the negatively charged first surface 106 of the conductor 102 while isolating the gas from the second surface 108.

Once inside the chamber 202, the CO₂ is brought into contact with the heated ionic conductor 102. A certain fraction of the CO₂ dissociates and the resulting free oxygen ions enter the conducting solid 102, which is held under an electric field. The oxygen becomes a negative ion (O⁻⁻) and is transported across the membrane (ionic conductor) 102. The result is that the CO₂ is dissociated and what is left on the first surface 106 of the ionic conductor 102 is powdered carbon 304. The carbon 304 falls to the bottom of the chamber 202 and is collected and disposed of or used. However, some C particles adhere to the surface of the conductor 102 and inhibit the conductor from acting as an oxygen-passing membrane. Therefore, it is advantageous to prevent the carbon powder from clinging to the surface 106 of the conductor 102.

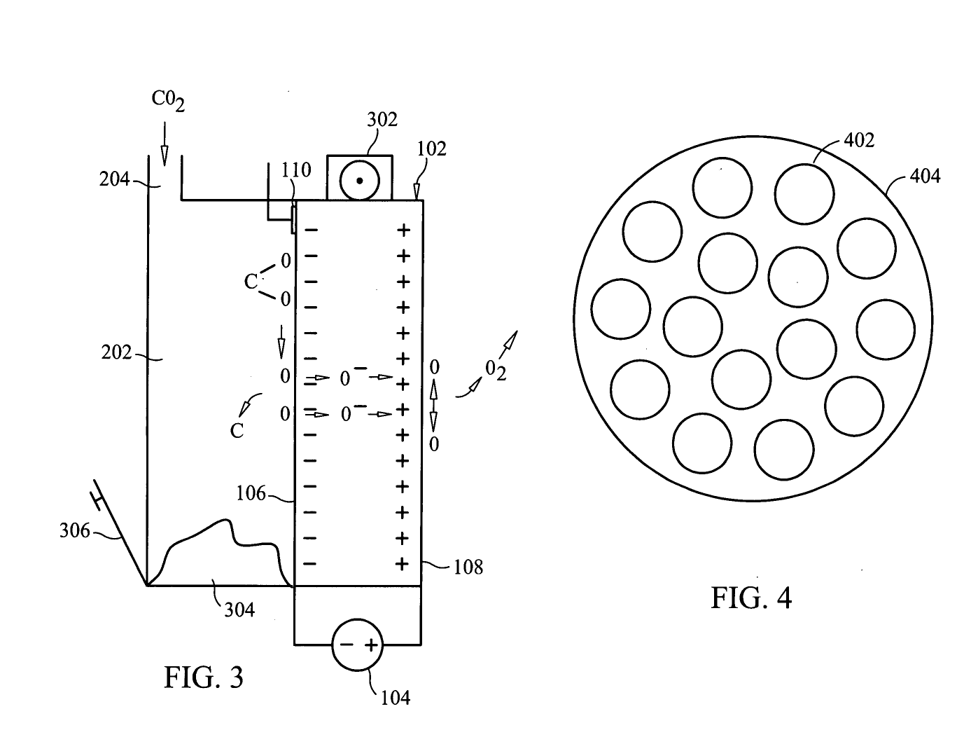

Referring now to the embodiment of FIG. 3, a vibration generator 302 is coupled to the ionic conductor 102. The vibration generator 302 shakes the ionic conductor 102 causing carbon deposits to become detached from the first surface 106 of the conductor 102. The carbon deposits fall to a bottom section of the chamber 202 where they are collected. An opening 306 is provided to remove the carbon deposits 304. In preferred embodiments, the opening 306 is constructed so as to allow removal of the carbon while keeping out any air from the surroundings and preventing the CO₂ within the chamber from escaping into the atmosphere.

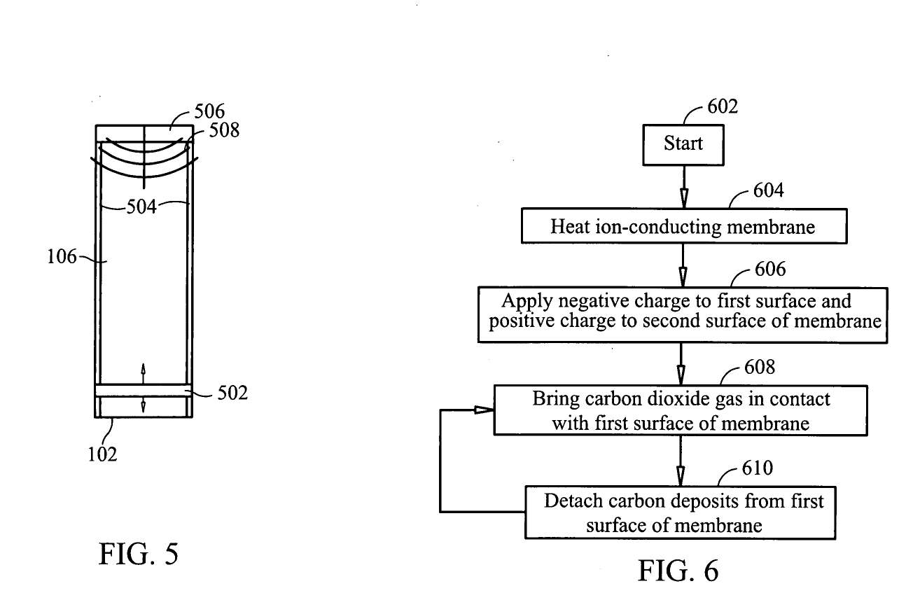

In one embodiment of the present invention shown in FIG. 5, focused ultrasonic soundwaves 508 are directed onto the conductor 102 by an ultrasonic wave generator 506. The waves 508 disrupt the surface 106 of the conductor 102 and cause the carbon particles to be displaced and fall to a bottom section of the chamber 202 (not shown).

In another embodiment of the present invention, also shown in FIG. 5, a scraper 502 is used to displace carbon deposits on the conductor 102. The scraper 502 can be used alternatively or in conjunction with the ultrasonic wave generator 506. The scraper 502 travels along a set of tracks 504 allowing the scraper 502 to longitudinally travel back and forth along the entire first surface 106 of the conductor 102 breaking loose any powdered carbon deposits. Other devices and methods can also be used to remove carbon deposits from the first surface 106 of the conductor 102 and are within the true spirit and scope of the present invention.

Utilizing present manufacturing techniques, there is a practical limitation on the maximum diameter of the ionic conductor 102 of approximately one foot. For large scale applications (e.g., coal plants producing electricity), where large amounts of CO₂ are being generated, it is possible to assemble an array of ionically conducting membranes 402, each one-foot in diameter or smaller, as dictated by the manufacturing limit, all arranged on a large circular plate 404, as shown in the embodiment of FIG. 4. The multiple membranes arranged in an array provide a larger surface area to be exposed to the CO₂. The array configuration allows a large volume of CO₂ to dissociate at a rapid rate. The circular plate 404 is made of a material that will withstand temperatures in the order of 1000° C. Examples are oxides, such as silica and alumina. Molybdenum and tungsten are metals that may also be used, but in this case, they could be protected by argon from the surrounding atmosphere.

The circular plate 404 is maintained in a vertical position, enclosed by appropriate large-scale piping in which the stream of CO₂, collected after incineration (and filtered free of solid particles), is brought from the originating plants into contact with a negatively charged surface of the plate 404, duly brought to a high temperature.

The production of hydrogen from coal is known in the art. The hydrogen is produced by grinding the coal into a powder-like consistency and then introducing super-heated steam at a high pressure. The result is CO₂ and H₂. In practice, the production of 1 Gigajoule of hydrogen through use of a powdered-coal/high-pressure steam process produces approximately 50 lbs of powdered carbon. With the current market price of carbon being approximately $0.25/lb, 1 Gigajoule of hydrogen will produce about $13 worth of carbon. Therefore, the present invention, which uses a commonly-recognized pollutant as fuel, results in a quantity of carbon that can be sold to recover a significant fraction of the operating costs involved in the process.

Referring now to FIG. 6, a process for sequestering carbon dioxide according to a preferred embodiment is shown. The process begins at step 602 and moves directly to step 604 where an ion-conducting membrane is heated. In step 606, a negative charge is applied to a first surface of the membrane and a positive charge is applied to a second surface of the membrane. Carbon dioxide gas is brought in contact with the first surface of the membrane in step 608. A device that detaches carbon deposits from the first surface of the conductor is utilized in step 610. The process moves from step 610 back to step 608.

As described above, the present invention eliminates environmentally hazardous carbon dioxide and produces pure oxygen and pure carbon powder, both of which can be returned safely to the environment or sold for profit. Additionally, the present invention can be implemented on a local scale and advantageously, does not require long expensive pipelines.

What is claimed is:

1. An apparatus for dissociating carbon dioxide molecules, the apparatus comprising:
an ion-conducting oxygen-permeable membrane having a first surface and a second surface opposite the first surface;
a power source for applying a first voltage to the first surface and a second voltage, which is greater than the first voltage, to the second surface; and
a chamber, mechanically coupled to the first surface, for containing CO₂ gas, such that the CO₂ gas within the chamber contacts the first surface of the membrane such that O atoms from the CO₂ gas contacting the first surface exit the second surface of the membrane.

2. The apparatus according to claim 1, wherein the ion-conducting membrane comprises at least one of ZrO₂, ZrO₂—Y₂O₃, and U₂O₈—Y₂O₃.

3. The apparatus according to claim 1, wherein each of the first and the second surfaces of the ion-conducting membrane are at least partially covered with one or more noble metals.

4. The apparatus according to claim 1, wherein the first surface of the ion-conducting membrane is at least partially coated with platinum.

5. The apparatus according to claim 1, wherein the second surface of the ion-conducting membrane is at least partially coated with ruthenium oxide.

6. The apparatus according to claim 1, where the power source develops an electric field of at least 10 volts per centimeter on the ion-conducting membrane.

7. The apparatus according to claim 1, further comprising:
a heating element for heating the ion-conducting membrane to a temperature greater than or equal to about 1000° C.

8. The apparatus according to claim 1, further comprising:
at least one of a vibration generator, an ultrasonic wave generator, and a scraper for causing carbon deposits to detach from the first surface of the ion-conducting membrane.

9. The apparatus according to claim 1, wherein an interior area of the chamber is isolated from the second surface of the membrane.

10. The apparatus according to claim 1, wherein the power source is a homopolar generator.

11. An apparatus for dissociating carbon dioxide molecules, the apparatus comprising:
membrane means for dissociating CO₂ gas into C and O atoms, the membrane means including a first surface for contacting the CO₂ gas and a second surface through which the O atoms exit; and
a power source for applying a first voltage to the first surface and a second voltage, which is greater than the first voltage, to the second surface so as to cause the membrane means to transport the O atoms from the first surface to the second surface.

12. The apparatus according to claim 11, wherein the membrane means comprises at least one of ZrO₂, ZrO₂—Y₂O₃, and U₂O₈—Y₂O₃.

13. The apparatus according to claim 11, wherein each of the first and the second surfaces of the membrane means are at least partially covered with one or more noble metals.

14. The apparatus according to claim 11, wherein the first surface of the membrane means is at least partially coated with platinum.

15. The apparatus according to claim 11, wherein the second surface of the membrane means is at least partially coated with ruthenium oxide.

16. The apparatus according to claim 11, further comprising:
a heating element for heating the ion-conducting membrane to a temperature greater than or equal to about 1000° C.

17. The apparatus according to claim 11, further comprising:
at least one of a vibration generator, an ultrasonic wave generator, and a scraper for causing carbon deposits to detach from the first surface of the membrane means.

18. The apparatus according to claim 11, a chamber that isolates the CO₂ from the second surface.

19. A method for dissociating carbon dioxide molecules, the method comprising the steps of:
heating an ion-conducting membrane having a first surface and a second surface opposite the first surface;
applying a first voltage to the first surface of the ion-conducting membrane;
applying a second voltage, which is greater than the first voltage, to the second surface of the ion-conducting membrane; and
contacting carbon dioxide gas with the first surface of the ion-conducting membrane.

20. The method according to claim 19, wherein the heating step comprises:
heating the ion-conducting membrane to a temperature greater than or equal to about 1000° C.

21. The method according to claim 19, wherein the applying steps create an electric field of about 10-30 volts per centimeter on the ion-conducting membrane.

22. The method according to claim 19, wherein the ion-conducting membrane includes at least one of ZrO₂, ZrO₂—Y₂O₃, and U₂O₈—Y₂O₃.

23. The method according to claim 19, further comprising the step of:
removing carbon deposits from the first surface of the ion-conducting membrane.

24. The method according to claim 23, wherein the removing step comprises at least one of the sub-steps of:
vibrating the ion-conducting membrane, scraping the ion-conducting membrane, and applying ultrasonic waves to the ion-conducting membrane so as to remove carbon deposits from the first surface of the ion-conducting membrane.
